(19) United States
(12) Patent Application Publication
(10) Pub. No.: US 2017/0183551 A1
(43) Pub. Date: Jun. 29, 2017

(54) POLYURETHANE ADHESIVE AND USE OF THE SAME

(71) Applicant: NAN YA PLASTICS CORPORATION, Taipei (TW)

(72) Inventors: Te-Chao LIAO, Taipei (TW); Cheng-Li CHAO, Taipei (TW); Chuan CHOU, Taipei (TW); Yung-Sheng WANG, Taipei (TW)

(21) Appl. No.: 15/384,618

(22) Filed: Dec. 20, 2016

(30) Foreign Application Priority Data
Dec. 24, 2015 (TW) 104143525

(51) Int. Cl. C09J 175/08; C08G 18/73; C08G 18/36; C09J 7/02; C08G 18/44; C08G 18/66; C09J 5/00; C08G 18/83; C08G 18/42

(52) U.S. Cl. CPC C09J 175/08; C08G 18/837; C08G 18/73; C08G 18/36; C08G 18/4238; C08G 18/44; C08G 18/6662; C09J 5/00; C09J 7/0285; C09J 7/0246; C08G 2170/40; C09J 2451/00; C09J 2467/006

(57) ABSTRACT

A polyurethane adhesive is formulated using a modified polyurethane copolymer, a curing agent and an antistatic agent, and the modified polyurethane copolymer is grafted a polysiloxane compound to a polyurethane polymer and made by esterifying a polyol, a hydroxyl-containing polysiloxane compound, a multi-functional isocyanate compound and a fatty acid ester; since the polyurethane adhesive is not yellowish and easy to dry as well as has excellent fabricability, air bleeding performance and transparency, when attached to surfaces of an optical or electronic device, the protective film leaves no residue and protects the surface of the device keeping no flaws.

### BACKGROUND OF THE INVENTION

1. Field of the Invention

The present invention relates to a polyurethane adhesive, and more particularly to a polyurethane adhesive so modified by grafting a polysiloxane compound that it is suited to be used as an adhesive layer of a protective film. Moreover, when the protective film is adhered to a surface of an optical or electronic device, the adhesive layer does not cause contamination.

2. Description of Related Art

Currently, peelable protective films (hereinafter shortened as protective films) are products that provide both adhesion and protection against dust and scrapes. During the process of processing, fabricating, assembling and transporting optical or electronic devices, theses protective films are generally used to protect the surfaces of the optical or electronic devices (hereinafter shortened as to-be-adhered devices).

A good protective film shall have the following qualities:

### 1. Having Excellent Air Bleeding Performance:

When the protective film is adhered to the surface of a to-be-adhered device, there should not be air bubbles existing between the protective film and the surface of the to-be-adhered device; and

### 2. Leaving No Adhesive Residue:

When the protective film was peeled from the surface of the to-be-adhered device, there should not be adhesive residue that contaminates the surface of the to-be-adhered device.

However, the adhesive surface of the protective film made of an acrylic resin is less favorable to air bleeding. When it is adhered to the surface of a to-be-adhered device, although there is no adhesive residue left, air bubbles exist between the protective film and the surface of the to-be-adhered device.

The adhesive surface of the protective film made of an un-modified polyurethane resin is less favorable to air bleeding. When it is adhered to the surface of a to-be-adhered device, there are some substances separated out and contaminated to the surface of the to-be-adhered device. In addition, un-modified polyurethane resins have inferior surface drying ability, and may slow down the coating process.

Even when the adhesive surface of the protective film is made of an un-modified polyurethane resin and a polysiloxane compound mixing together, if the un-modified polyurethane resin is mixed with the polysiloxane compound after synthesis, the polysiloxane compound is only blended in and does not participate in synthesis of the polyurethane resin. During drying, the polysiloxane compound and the un-modified polyurethane resin may not react and combine together, and there may be some part of the polysiloxane compound remained not grafted. When such a protective film is adhered to the surface of a to-be-adhered device, the polysiloxane compound tends to be separated out and gradually migrate to the surface of the to-be-adhered device (hereinafter shortened as a migration) over time or under high temperature, in turn contaminating the surface of the to-be-adhered device.

Additionally, in the existing technology, the adhesive surface of the protective film usually contains an antistatic agent for reducing surface resistivity, but this makes the adhesive surface of the protective film more tend to yellow under high temperature.

### SUMMARY OF THE INVENTION

For addressing the problems of the adhesive surface of the prior-art protective films about air bleeding performance and adhesive residue, the disclosed polyurethane adhesive is formulated using a polyurethane copolymer modified by grafting a polysiloxane compound (hereinafter shortened as a modified polyurethane copolymer (A)). Opposite to an un-modified polyurethane polymer or a normal polyurethane adhesive that has a polysiloxane compound added after synthesis, the modified polyurethane copolymer (A) component does not separate out the polysiloxane compound or other substances over time or under high temperature, thus having excellent non-migration.

The primary objective of the present invention is to disclose a polyurethane adhesive that is formulated using a modified polyurethane copolymer (A), a curing agent (B), and an antistatic agent (C). Therein, the key for synthesizing the modified polyurethane copolymer (A) is to add a polysiloxane compound having hydroxyl reactive functional groups (OH groups) and an appropriate amount of a fatty acid ester during esterification of polyol and isocyanate. The modified polyurethane copolymer (A) so produced has a chemical structure that completely grafts the polysiloxane compound to the polyurethane polymer. It not only is suitable for polyurethane adhesives used for making the adhesive surface of a protective film, but also improves the adhesive surface of the protective film in terms of air bleeding performance, transparency, resistance to yellowing, and non-migration.

The disclosed modified polyurethane copolymer (A) is made by esterifying the following monomer components in amounts stated below, and has excellent fabricability, air bleeding performance, transparency, and resistance to yellowing:
a. 100 wt % of a polyol, which polyol has two or more OH groups and has a number-average molecular weight (Mn) of 1000-10000;
b. 2-20 wt % of a hydroxyl-containing polysiloxane compound based on the polyol's weight, which has the structure expressed by the structural formula below:

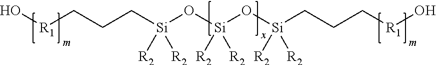

where, x and m are positive integers greater than or equal to 0;
R1 is selected from polyethylene oxide (EO), polypropylene oxide (PO) or polybutylene oxide (BO); and
R2 is selected from methyl, ethyl, propyl or phenyl;
c. 14-18 wt % of a multi-functional isocyanate compound, based on the polyol's weight; and
d. 14-16 wt % of a fatty acid ester, based on the polyol's weight.

The disclosed polyurethane adhesive contains a modified polyurethane copolymer (A), a curing agent (B) and an antistatic agent (C). The curing agent (B) is used in an amount of 14-18 wt % and the antistatic agent (C) is used in an amount of 0.05-5 wt % based on the weight of the polyol in the modified polyurethane copolymer (A).

The disclosed polyurethane adhesive contains the antistatic agent (C) that is any one or a combination of cationic antistatic agents and anionic antistatic agents. It has excellent antistatic capacity and has a surface resistivity of up to 10⁹Ω/□.

Another primary objective of the present invention is to provide a protective film that includes a substrate layer having a thickness of 10-100 μm and an adhesive layer having a thickness of 1-50 μm, wherein the adhesive layer is made by applying the disclosed polyurethane adhesive to the substrate layer and curing the polyurethane adhesive.

The adhesive surface of the disclosed protective film has an initial adhesion (peel) strength to a glass plate of ranging from 1 g/25 mm to 3 g/25 mm. The protective film of the present invention has the following beneficial effects:
1. The disclosed polyurethane adhesive and the adhesive surface of the disclosed protective film are formulated using a special modified polyurethane copolymer (A). As compared to un-modified polyurethane copolymers, the special copolymer is more able to untangle the polyurethane polymer in the polyurethane adhesive and in the adhesive surface of the protective film. This not only improves the wetting adhesion between the polyurethane adhesive and the object it is applied to, but also improves the polyurethane adhesive and the adhesive surface of the protective film in terms of non-migration.
2. The disclosed polyurethane adhesive has excellent fabricability, air bleeding performance, transparency, and resistance to yellowing, and is suitable for the adhesive surface of a protective film.
3. The adhesive surface of the disclosed protective film has excellent air bleeding performance, transparency, adhesion, resistance to yellowing, and non-migration, and allows the protective film, when adhered to a surface of an optical or electronic device, to protect the optical or electronic device from damage during processing, assembly or transport.

### BRIEF DESCRIPTION OF THE DRAWINGS

FIG. 1 is a schematic drawing showing the polyurethane adhesive of the present invention suitably used as an adhesive layer for a three-layer protective film.

### DETAILED DESCRIPTION OF THE INVENTION

The polyurethane adhesive of the present invention is formulated using the modified polyurethane copolymer (A) together with a curing agent (B) and an antistatic agent (C). It has excellent fabricability, air bleeding performance, transparency, resistance to yellowing, and non-migration. Additionally, for diversifying the applications of the disclosed polyurethane adhesive, other modifiers (D) may be optionally added into the formulation.

The modified polyurethane copolymer (A) is made by acting a polysiloxane compound containing hydroxyl reactive functional groups (hereinafter shortened as the hydroxyl-containing polysiloxane compound) with a polyol, a multi-functional isocyanate compound and fatty acid ester through esterification. The resulting modified polyurethane copolymer (A) has a chemical structure that completely grafts the polysiloxane compound to the polyurethane polymer.

The modified polyurethane copolymer (A) contains the monomers in amounts based on the weight of the polyol:
a. the polyol of 100 wt %;
b. the hydroxyl-containing polysiloxane compound of 2-20 wt %; preferably 4-15 wt %; and more preferably 6-10 wt %;
c. the multi-functional isocyanate compound of 14-18 wt %; and
d. the fatty acid ester of 14-16 wt %; and preferably 15 wt %.

The polyol must be a polyol having two or more hydroxyl groups (OH groups) and having a number-average molecular weight (Mn) of 1,000-10,000; preferably 1,500-8000; and more preferably 2,000-5,000.

Examples of the polyol include polyester polyols and polyether polyols. Therein, the polyester polyol may be prepared by esterifying a polyol component (E1) and an acid component (E2).

The polyol component (E1) is any one or any combination of two or more selected from glycol, 1,4-butanediol, 3-methyl-1,5-pentylene glycol, 2,4-diethyl-L5-pentylene glycol, 1,6-hexylene glycol and 2-methyl-1,8-octylene glycol.

The acid component (E2) is any one or any combination of two or more selected from adipic acid, succinic acid, methyl succinic acid, heptanedioic acid, azelaic acid, decanedioic acid, terephthalic acid, m-phthalic acid, phthalate acid, m-phthalic acid, and phthalate acid.

Additionally, the polyether polyol may be made by performing addition polymerization of a polyol component (E3) and an alkylene oxide (E4). The polyol component (E3) is any one or any combination of two or more selected from polyglycol, poly propylene glycol, poly 1,4-butanediol and poly 1,6-hexylene glycol. The alkylene oxide (E4) is any one or any combination of two or more selected from p-ethylene oxide, propylene oxide and butylene oxide.

The hydroxyl-containing polysiloxane compound has a structure expressed by the structural formula below:

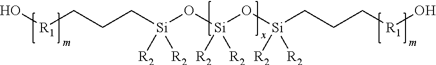

where, x and m are positive integers greater than or equal to 0;
R1 is selected from polyethylene oxide (EO), polypropylene oxide (PO) or polybutylene oxide (BO); and
R2 is selected from methyl, ethyl, propyl or phenyl.

The multi-functional isocyanate compound is any one or any combination of two or more selected from a multi-functional aliphatic isocyanate compound, a multi-functional alicyclic isocyanate compound, and a multi-functional aromatic isocyanate compound.

The purpose for the disclosed polyurethane copolymer (A) to contain 14-16 wt % of one or more fatty acid esters based on the polyol's weight is to speed up air bleeding of the polyurethane copolymer (A).

When the content of the fatty acid ester is below 14 wt %, the speed of air bleeding cannot be effectively improved. When the content is higher than 16 wt %, the fatty acid ester tends to be separated out to the surface of the to-be-adhered object under high temperature. Particularly, excessive use of the fatty acid ester can have adverse impact on the drying ability of the coated surface, and in turn slow down the coating lines.

The fatty acid ester is any one or any combination of two or more selected from isopropyl laurate, isopropyl myristate, isopropyl palmitate, monobehenin, 2-ethylhexyl stearate, behenic monoglyceride, hexadecyl 2-ethylhexanoate, lauryl methacrylate, coconut fatty acid methyl ester, octyldodecyl myristate, pentaerythritol monooleate, pentaerythritol monostearate, stearyl stearate, methyl laurate, methyl stearate, octyl oleate, isotridecyl stearate, and butyl laurate.

The method for preparing the polyurethane copolymer (A) involves: placing a 2-functional-group-containing polyol, some of the 3-functional-group-containing polyols, a polysiloxane compound, a fatty acid ester, and some of the solvents into a reactor; heating and stirring; adding some of the isocyanate compounds after the mixture is heated to 50° C.; performing reaction for 30 minutes; adding a little catalyst; performing reaction for 30 minutes; adding the remaining 3-functional-group-containing polyol, heating to 75° C. and performing reaction for 1.5 hours; adding the remaining isocyanate compound, holding the temperature for reaction for 4 hours; sampling and testing to confirm there is no isocyanate (NCO functional group) residual and the desired molecular weight is reached; adding the remaining solvent and stirring for 30 minutes; and finishing the process.

The disclosed polyurethane adhesive, when formulated using the polyurethane copolymer (A) together with the curing agent (B) and the antistatic agent (C) is ready to be used after mixed evenly. The disclosed polyurethane adhesive when provided with the special combination of antistatic agents added has an excellent antistatic capacity and has a surface resistivity of up to 10⁹Ω/□.

The curing agent (B) is used in an amount of 14-18 wt % by weight of the foregoing polyol. The curing agent (B) is one or a combination of aromatic polyisocyanate-based curing agent, aliphatic polyisocyanate-based curing agent or alicyclic isocyanate-based curing agent. The aromatic polyisocyanate-based curing agent includes toluene diisocyanate (TDI) curing agents or diphenyl (MDI) curing agents, such as Desmodur IL1351, IL1451 or L75 produced by Bayer Company, Germany. The aliphatic polyisocyanate-based curing agent may be a hexamethylene diisocyanate (HDI) curing agent, such as Desmodur N3300 produced by the Bayer Company.

The antistatic agent (C) is used in an amount of 0.05-5 wt % by weight of the foregoing polyol. The antistatic agent (C) is any one or any combination selected from cationic antistatic agents and anionic antistatic agents. Therein, the cationic antistatic agent has a structure expressed by the structural formula below:

R₄NX or R_{N}NY;
where, n=1, 2 or 3; R represents alkyl; X is halogen;
   Y is hydrochloric acid, formic acid or acetic acid; and
   N is nitrogen.

The cationic antistatic agent may be selected from quaternary ammonium salts or amine salts, which cationic antistatic agent features high polarity, excellent antistatic ability and high adhesion to high molecular materials, yet has inferior thermal stability.

The cationic antistatic agent has a structure expressed by the structural formula below:

RCOO⁻M⁺, RSO₃⁻M⁺ or ROSO₃⁻M⁺;
where, M⁺ is an alkali metal ion, ammonium or an organic amine;
   R is alkyl.

The anionic antistatic agent may be selected from alkyl sulfate, sulfate, phosphate, higher fatty acid salts, carboxylate, dithiocarbamate, or polymeric anionic antistatic agents. It features good heat resistance and antistatic ability. However, it is less compatible to resins, and thus has adverse impact on transparent products.

When using a combination of a cationic antistatic agent and an anionic antistatic agent, the disclosed polyurethane adhesive achieves good resistance to yellowing under high temperature, lower surface resistivity, and better compatibility. Therein, the optimal ratio between the anionic antistatic agent and the cationic antistatic agent is ranged from 4.5:1 to 5.5:1, preferably 5:1 to 5.25:1.

Without compromising its basic effects, the disclosed polyurethane adhesive may have an appropriate amount of a modifier (D) add therein according to its practical use. The modifier (D) maybe any one or any combination of two or more selected from UV absorbers, anti-oxidants, preservatives, mildew proofing agents, bodying resins, plasticizers, defoamants, and wetting agents.

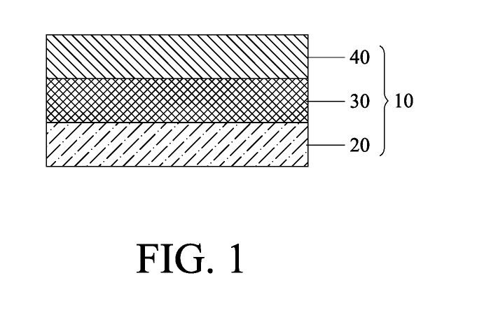

As shown in FIG. 1, the disclosed polyurethane adhesive of the present invention is suitably used as an adhesive layer 30 for a protective film 10. In particular, the protective film 10 has a substrate layer 20, an adhesive layer 30 coated on the substrate layer 20, and a release film 40 removably adhered to the adhesive layer 30. Accordingly, the protective film 10 is a peelable protective film configured to be adhered to the surface of an optical or electronic device.

The substrate layer 20 of the protective film 10 may be made of PET and has a thickness of 10-100 μm, preferably 15-75 μm, and more preferably 20-50 μm.

The adhesive layer 30 of the protective film 10 formed from the disclosed polyurethane adhesive of the present invention has an excellent fabricability, so it can be evenly applied to the substrate layer 20. And, the adhesive layer 30 has a thickness of 1-50 μm, preferably 5-25 μm, and more preferably 10-15 μm.

The release film 40 of the protective film 10 has its surface contacting the adhesive layer 30 coated with a polysiloxane-based release agent. It is unlikely to adhere to the adhesive layer 30, and is easy to be peeled from the adhesive layer 30. The release film 40 has a thickness of 10-100 μm, preferably 15-75 μm, and more preferably 20-50 μm.

The adhesive layer 30 of the protective film 10 formed from the disclosed polyurethane adhesive of the present invention has appropriate adhesion. The adhesive layer 30 has an initial adhesion (peel) strength below 10 g/25 mm to a glass plate, preferably below 5 g/25 mm, and more preferably ranged from 1 g/25 mm to 3 g/25 mm.

The adhesive layer 30 of the protective film 10 formed from the disclosed polyurethane adhesive has good transparency. When applied to the substrate layer 20 which is a photopermeable substrate, it improves the protective film 10 in terms of haze, which is below 4%, preferably below 3%, and more preferably below 2.5%.

The adhesive layer 30 of the protective film 10 formed from the disclosed polyurethane adhesive has good air bleeding performance, resistance to yellowing, and non-migration. When the protective film 10 is adhered to the surface of an optical or electronic device, the adhesive layer 30 of the protective film 10 provides quick air expelling and air bleeding, thereby allowing the protective film 10 to be smoothly adhered to surface of the optical or electronic device.

Besides, the protective film 10 has good transparency. After long-term use on the surface of the optical or electronic device, it remains clear and does not yellow, enabling accurate check of any damages or defects of the surface of the optical or electronic device. Even when the protective film 10 is removed from the surface of the optical or electronic device after a long term, the adhesive layer 30 of the protective film 10 does not separate out adhesive component, and does not contaminate the surface of the optical or electronic device.

The following examples and comparative examples are described for illustrating the present invention and are not intended to limit the scope of the present invention.

The protective films made in the examples and comparative examples were cut into test specimens of 100 mm in length×25 mm in width. These test specimens were tested for their physical properties using the methods described below:

### 1. Air Bleeding Performance:

The test specimen with its release film removed is held by two hands at two ends of its width. The test specimen has its middle part contact a glass plate first while the two ends thereof are slightly lifted. Then the two hands started to release the test specimen. The time for the test specimen to completely fit on the glass plate is recorded. The shorter time is associated to the better air bleeding performance
Test result are ranked into three levels including “good”, “fair” and “poor”, each level is defined as follows:
a. Ranking of “good” indicates that the air bleeding time was shorter than 1 second;
b. Ranking of “fair” indicates that the air bleeding time was 1-1.5 seconds; and
c. Ranking of “poor” indicates that the air bleeding time was longer than 2 seconds.

### 2. Transparency:

The test specimen with its release film removed is tested using a haze meter (Brand: Tokyo Denshoku, Model: TC-H DPK) for its haze and transmittance.
Test result are ranked into three levels including “good”, “fair” and “poor”, each level is defined as follows:
a. Ranking of “good” indicates that the test specimen had good transparency;
b. Ranking of “fair” indicates that the test specimen had acceptable transparency; and
c. Ranking of “poor” indicates that the test specimen had poor transparency.

### 3. Yellowing Under High Heat:

In an environment under temperature of 25° C. and humidity of 50% RH, the adhesive layer of the test specimen is adhered to a glass plate, and the specimen and the plate are then pressed by a 2 kg roller moving to and fro for once. The combination is placed into a 150° C. oven for 3 hours, removed from the oven, and set aside for 30 minutes before observed for any yellowing of the specimen and residue on the glass.
Test result are ranked into three levels including “level 1”, “level 2” and “level 3”, each level is defined as follows:
a. Ranking of “level 1” indicates that the test specimen showed no yellowing or residue;
b. Ranking of “level 2” indicates that the test specimen showed very slight yellowing or residue; and
c. Ranking of “level 3” indicates that the test specimen showed yellowing and adhesive residue.

### 4. Adhesion:

In an environment under temperature of 25° C. and humidity of 50% RH, the adhesive layer of the test specimen is adhered to a glass plate, and the specimen and the plate are pressed by a 2 kg roller moving to and fro for once. After 30 minutes, with the peeling parameters of the peeling angle of 180 degrees and the stretching speed of 300 mm/min, the test specimen is tested using a universal tensile testing machine for its adhesion force.

### 5. Surface Resistivity (Ω/□):

The test specimen with its release film removed is tested using a surface resistivity tester (Brand: Advantest, Model: R8340A Ultra High Resistance Meter+TR 300C Testing Box) for the surface resistivity of its adhesive surface.

### 6. Drying Speed:

The adhesive is applied to a PET substrate using a coating knife and placed into a 150° C.-oven for 1 minute. The dried film is as thick as 12-15 μm. The drying ability is determined using finger touch.
Test result are ranked into three levels including “good”, “fair” and “poor”, each level is defined as follows:
a. Ranking of “good” indicates that the test specimen had good drying ability;
b. Ranking of “fair” indicates that the test specimen had acceptable drying ability; and
c. Ranking of “poor” indicates that the test specimen had poor drying ability.

### 7. Migration:

In an environment under temperature of 25° C. and humidity of 50% RH, the adhesive layer of the test specimen is adhered to a glass plate, and the specimen and the plate are pressed by a 2 kg roller moving to and fro for once. Then the combination is placed into an oven at 85° C. for 500 hours, removed from the oven, and set aside for 30 minutes before observed for any migrant (i.e., polysiloxane compound) migrated to the surface of the glass plate.
Test result are ranked into three levels including “none”, “slight” and “great”, each level is defined as follows:
a. Ranking of “none” indicates that the test specimen showed no migrant on the surface of the glass plate, and thus had good non-migration;
b. Ranking of “slight” indicates that the test specimen showed a litter bite of migrant migrated to the surface of the glass plate; and
c. Ranking of “great” indicates that the test specimen showed a great amount of migrant migrated to the surface of the glass plate, and thus had poor non-migration.

### EXAMPLE 1

As shown in Table 1, 50 parts by weight of polyol DL3000 (i.e., polyoxypropylene glycol, shortened as PPG, Mn=3000) containing two OH functional groups, 30 parts by weight of Kuraray Polyol P-5010 containing two OH groups (i.e., poly[(3-methyl-1,5-pentanediol)-alt-(adipic acid)], Mn=5000), 15 parts by weight of polyol PC3000 containing three OH groups (i.e., polycarbonate polyol, Mn=3000), 8 parts by weight of polyether silicone oil SF 8427 containing two OH groups (Dow Corning Corporation), and 150 parts by weight of ethyl acetate as the diluting solvent were placed in a reactor, and 15 parts by weight of a fatty acid ester (isopropyl palmitate, Mn=299) was added. While heating to 50° C. and stirring, 11 parts by weight of hexamethylene diisocyanate (HDI) was added. After 30-minute reaction, a little catalyst was added. After 30-minute reaction, the remaining 5 parts by weight of the polyol containing 3 functional groups was added. The mixture was heated to 75° C. for reaction for 1.5 hours. Afterward, the remaining 2 parts by weight of hexamethylene diisocyanate (HDI) was added, and the temperature was held for reaction for 4 hours. After the mixture was sampled and test to confirm there was no NCO functional group residual and the desired molecular weight reached, the remaining solvent was added and stirring was performed for 30 minutes before the polyurethane resin was done. Then 16 parts by weight of a three-functional-group alicyclic curing agent Desmodur N3300 (Bayer Company) and 5 parts by weight of an antistatic agent that contained 0.80 parts by weight of the ionic liquid IL-P14 (Koei Chemical Company, Limited.) and 4.2 parts by weight of the anionic antistatic agent EF15 (Mitsubishi Chemical Holdings) were added. Stirring was performed for 5 minutes before the polyurethane resin was done.

The urethane-based adhesive so produced was applied to a PET substrate film (having a thickness of 38 μm) using a coating knife. After cured at 115° C. for 3 minutes, the adhesive formed an adhesive layer covering the PET substrate film. The cured adhesive had a thickness of 12 μm. Then a 38 μm-thick PET release film covered with a polysiloxane release agent was attached to the adhesive layer to produce a protective film.

The protective film so produced was tested for its physical properties, and the results are shown in Table 1.

### EXAMPLE 2

The adhesive was made according to the method used in Example 1, but polyether silicone oil CS3505 was used instead of the polyether silicone oil, and the fatty acid ester used was isoproply myristate, while the antistatic agent used was 0.04 parts by weight of the ionic liquid IL-P14 and 0.2 parts by weight of the anionic antistatic agent EF15 instead.

The protective film so produced was tested for its physical properties, and the results are shown in Table 1.

### EXAMPLE 3

The adhesive was made according to the method used in Example 1, but polyether silicone oil KF-6001 (Shin-Etsu Company) was used instead of the polyether silicone oil, and the antistatic agent used was amount of 0.45 parts by weight of the ionic liquid IL-P14 and 2.25 parts by weight of the anionic antistatic agent EF15 instead.

The protective film so produced was tested for its physical properties, and the results are shown in Table 1.

### EXAMPLE 4

The adhesive was made according to the method used in Example 1, but the fatty acid ester (isopropyl palmitate, Mn=299) was used in an amount of 14 parts by weight instead, and the antistatic agent was 0.08 parts by weight of ionic liquid IL-P14 and 0.4 parts by weight of anionic antistatic agent EF15 instead.

The protective film so produced was tested for its physical properties, and the results are shown in Table 1.

### EXAMPLE 5

The adhesive was made according to the method used in Example 4, but the polyether silicone oil used was polyether silicone oil KF-6001 (Shin-Etsu Company) instead, and the fatty acid ester (isopropyl palmitate, Mn=299) was used in an increased amount of 16 parts by weight instead.

The protective film so produced was tested for its physical properties, and the results are shown in Table 1.

### EXAMPLE 6

The adhesive was made according to the method used in Example 5, but the fatty acid ester (isopropyl palmitate, Mn=299) was used in a decreased amount of 15 parts by weight instead.

The protective film so produced was tested for its physical properties, and the results are shown in Table 1.

### COMPARATIVE EXAMPLE 1

The adhesive was made according to the method used in Example 1 but was formulated without the use of the polysiloxane compound, the fatty acid ester, and the antistatic agent.

The protective film so produced was tested for its physical properties, and the results are shown in Table 2.

### COMPARATIVE EXAMPLE 2

The adhesive was made according to the method used in Example 1, but as formulated without the use of the polysiloxane compound and the antistatic agent.

The protective film so produced was tested for its physical properties, and the results are shown in Table 2.

### COMPARATIVE EXAMPLE 3

The adhesive was made according to the method used in Comparative Example 2, but the fatty acid ester (isopropyl palmitate, Mn=299) was used in an increased amount of 30 parts by weight instead, and 5.5 parts by weight of the antistatic agent used including 0.90 parts by weight of the ionic liquid IL-P14 and 4.5 parts by weight of EF15.

The protective film so produced was tested for its physical properties, and the results are shown in Table 2.

### COMPARATIVE EXAMPLE 4

The adhesive was made according to the method used in Comparative Example 2, but the fatty acid ester (isopropyl palmitate, Mn=299) was used in an increased amount of 17 parts by weight instead, and 0.24 parts by weight of the antistatic agent IL-P14 was used.

The protective film so produced was tested for its physical properties, and the results are shown in Table 2.

### COMPARATIVE EXAMPLE 5

The adhesive was made according to the method used in Comparative Example 2, but had 0.08 parts by weight of the antistatic agent IL-P14 add therein.

The protective film so produced was tested for its physical properties, and the results are shown in Table 2.

### COMPARATIVE EXAMPLE 6

The adhesive was made according to the method used in Comparative Example 2, but used 0.08 parts by weight of the antistatic agent IL-P14 and 0.4 parts by weight of the antistatic agent EF15 instead.

The protective film so produced was tested for its physical properties, and the results are shown in Table 2.

### COMPARATIVE EXAMPLE 7

The adhesive was made according to the method used in Comparative Example 2, but additionally used the polysiloxane compound and the antistatic agent, including adding 8 parts by weight of polyether silicone oil SF8427 and 0.24 parts by weight of the antistatic agent IL-P14.

The protective film so produced was tested for its physical properties, and the results are shown in Table 2.

### COMPARATIVE EXAMPLE 8

The adhesive was made according to the method used in Comparative Example 7, but used polyether silicone oil KF6001 instead of polyether silicone oil SF8427.

The protective film so produced was tested for its physical properties, and the results are shown in Table 2.

### COMPARATIVE EXAMPLE 9

The adhesive was made according to the method used in Comparative Example 2 and also used isopropyl palmitate as the fatty acid ester, but 8 parts by weight of polyether silicone oil SF8427 was added after the synthesis of the polyurethane resin was completed.

The protective film so produced was tested for its physical properties, and the results are shown in Table 2.

### COMPARATIVE EXAMPLE 10

The adhesive was made according to the method used in Comparative Example 2, but isoproply myristate was used instead of the fatty acid ester, and 8 parts by weight of polyether silicone oil CS3505 was added after synthesis of the polyurethane resin was completed instead.

The protective film so produced was tested for its physical properties, and the results are shown in Table 2.

TABLE 1

| | | | Examples | | | | | |
|---|---|---|---|---|---|---|---|---|
| | | | 1 | 2 | 3 | 4 | 5 | 6 |
| Polyurethane | Polyol | DL3000 | 50 | 50 | 50 | 50 | 50 | 50 |
| Adhesive | | P-5010 | 30 | 30 | 30 | 30 | 30 | 30 |
| | | PC3000 | 20 | 20 | 20 | 20 | 20 | 20 |
| | Isocyanate | HDI | 13 | 13 | 13 | 13 | 13 | 13 |
| | Compound | | | | | | | |
| | Polysiloxane | SF8427 | 8 | — | — | 8 | — | — |
| | Compound*¹ | CS3505*² | — | 8 | — | — | — | — |
| | | KF6001 | — | — | 8 | — | 8 | 8 |
| | Fatty Acid | Isopropyl | — | 15 | — | — | — | — |
| | Ester | Myristate | | | | | | |
| | | Isopropyl | 15 | — | 15 | 14 | 16 | 15 |
| | | Palmitate | | | | | | |
| | Curing Agent | N3300 | 16 | 16 | 16 | 16 | 16 | 16 |
| | Antistatic | IL-P14 | 0.80 | 0.04 | 0.45 | 0.08 | 0.08 | 0.08 |
| | Agent | EF15 | 4.2 | 0.2 | 2.25 | 0.4 | 0.4 | 0.4 |

| | | | | | | | |
|---|---|---|---|---|---|---|---|
| Physical | Air Bleeding Performance | good | good | good | good | good | good |
| Properties | Haze (%) | 1.88 | 1.89 | 1.89 | 1.89 | 1.89 | 1.87 |
| | Transparency | fair | good | good | good | good | good |
| | Yellowing at 150° C. | level 1 | level 1 | level 1 | level 1 | level 1 | level 1 |
| | Adhesion (g/25 mm) | 2.6 | 2.8 | 2.5 | 2.6 | 2.5 | 2.3 |
| | Fabricability | good | good | good | good | good | good |
| | Surface Resistivity (Ω/□) | 10⁹ | 10⁹ | 10⁹ | 10⁹ | 10⁹ | 10⁹ |
| | Drying Speed | fair | fair | fair | fair | fair | fair |
| | Migration | None | None | None | None | None | None |

Note: 1. The polysiloxane compounds used were polyether silicone oil SF8427, CS3505, and KF6001.
   2. Polyether silicone oil CS3505 has a weight-average molecular weight (Mw) of 2800, manufactured by Momentive Performance Materials Inc.

TABLE 2

| | | | Comparative Examples | | | | | | | | | |
|---|---|---|---|---|---|---|---|---|---|---|---|---|
| | | | 1 | 2 | 3 | 4 | 5 | 6 | 7 | 8 | 9 | 10 |
| Polyurethane | Polyol | DL3000 | 50 | 50 | 50 | 50 | 50 | 50 | 50 | 50 | 50 | 50 |
| Adhesive | | P-5010 | 30 | 30 | 30 | 30 | 30 | 30 | 30 | 30 | 30 | 30 |
| | | PC3000 | 20 | 20 | 20 | 20 | 20 | 20 | 20 | 20 | 20 | 20 |
| | Isocyanate | HDI | 13 | 13 | 13 | 13 | 13 | 13 | 13 | 13 | 13 | 13 |
| | Compound | | | | | | | | | | | |
| | Polysiloxane | SF8427 | — | — | — | — | — | — | 8 | — | 8 | — |
| | Compound*¹ | CS3505*² | — | — | — | — | — | — | — | — | — | 8 |
| | | KF6001 | — | — | — | — | — | — | | 8 | — | — |
| | Fatty Acid | Isopropyl | — | — | — | — | — | — | — | — | — | 15 |
| | Ester | Myristate | | | | | | | | | | |
| | | Isopropyl | — | 15 | 30 | 17 | 15 | 15 | 15 | 15 | 15 | — |
| | | Palmitate | | | | | | | | | | |
| | Curing Agent | N3300 | 16 | 16 | 16 | 16 | 16 | 16 | 16 | 16 | 16 | 16 |
| | Antistatic | IL-P14 | — | — | 0.9 | 0.24 | 0.08 | 0.08 | 0.24 | 0.24 | — | — |
| | Agent | EF15 | — | — | 4.5 | — | — | 0.4 | — | — | — | — |

| | | | | | | | | | | | |
|---|---|---|---|---|---|---|---|---|---|---|---|
| Physical | Air Bleeding Performance | poor | fair | good | fair | fair | fair | good | good | fair | fair |
| Properties | Haze (%) | 1.87 | 1.85 | 1.86 | 1.88 | 1.86 | 1.87 | 1.88 | 2.37 | 1.89 | 1.87 |
| | Transparency | good | good | fair | fair | fair | fair | fair | good | fair | good |
| | Yellowing at 150° C. | level 1 | level 1 | level 3 | level 3 | level 1 | level 1 | level 3 | level 3 | level 2 | level 2 |
| | Adhesion (g/25 mm) | 3.0 | 2.8 | 2.6 | 2.5 | 2.7 | 2.6 | 2.4 | 26 | 2.7 | 2.7 |
| | Fabricability | good | good | good | good | good | good | good | good | fair | fair |
| | Surface Resistivity (Ω/□) | 10¹¹ | 10¹¹ | 10⁹ | 10⁹ | 10¹⁰ | 10⁹ | 10⁹ | 10⁹ | 10¹¹ | 10¹¹ |
| | Drying Speed | fair | fair | poor | poor | fair | fair | fair | fair | fair | fair |
| | Migration | slight | slight | great | great | great | slight | slight | slight | great | great |

### Results:

1. According to the test results shown in Table 1 and Table 2, it is found that the polyurethane adhesives of Examples 1-6 exhibited excellent fabricability, air bleeding performance, transparency, resistance to yellowing, and non-migration, making them suitable to be used as the adhesive layer of a protective film. Therefore, the protective films of Examples 1-6 have excellent air bleeding performance, transparency, adhesion force and yellowing resistance. In addition, the adhesive surfaces of the adhesive layers also have excellent surface resistivity and non-migration.
2. By comparing the results of Examples 4-6 and the results of Comparative Example 6, it is clear that the polyurethane adhesives of Examples 4-6 containing the polysiloxane compound do contribute to good air bleeding performance, transparency, adhesion force and non-migration of the protective films made therefrom.
3. Comparison between the results of Comparative Example 5 and the results of Comparative Example 6 proves that the protective film using the polyurethane adhesive of Comparative Example 6 that was made of two antistatic agents, IL-P14 and EF15, had the surface resistivity (Ω/□) at its adhesive surface drop to 10⁹Ω/□ from 10¹⁰Ω/□.
4. The polyurethane adhesive of Examples 1-6 was formulated using two antistatic agents, IL-P14 and EF15, and effectively caused the protective films made from the polyurethane adhesive of Examples 1-6 to have their adhesive surface resistivity reduce to 10⁹Ω/□.
5. The polysiloxane compounds of Example 1-2 were added during synthesis of the polyurethane resin and participated in the reaction. Differently, the polysiloxane compounds of Comparative Examples 9-10 were added after the synthesis of the polyurethane resin. The protective films made from Examples 1-2 showed excellent resistance to yellowing under high temperature (up to 150° C.), and did not leave residue on the glass plate it attached, thus having outstanding non-migration.

What is claimed is:

1. A polyurethane adhesive, being formulated using a modified polyurethane copolymer (A), a curing agent (B) and an antistatic agent (C), wherein
the modified polyurethane copolymer (A) being grafted a polysiloxane compound to a polyurethane polymer and made by esterifying the following monomer components:
a. 100 wt % of a polyol, being a polyester polyol or a polyether polyol having two or more hydroxyl groups and having a number-average molecular weight (Mn) of 1000-10000;
b. 2-20 wt % of a hydroxyl-containing polysiloxane compound by weight of the polyol, which structural formula is as follows: 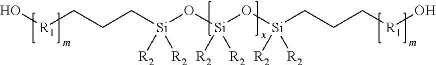
where, x and m are positive integers greater than or equal to 0;
R1 is selected from polyethylene oxide (EO), polypropylene oxide (PO) or polybutylene oxide (BO); and
R2 is selected from methyl, ethyl, propyl or phenyl;
c. 14-18 wt % of a multi-functional isocyanate compound by weight of the polyol; and
d. 14-16 wt % of a fatty acid ester by weight of the polyol;
the curing agent (B) in an amount of 14-18 wt % by weight of the polyol; being one or a combination of aromatic polyisocyanate-based curing agents, aliphatic polyisocyanate-based curing agents or alicyclic isocyanate-based curing agents and
the antistatic agent (C) in an amount of 0.05-5 wt % by weight of the polyol, being a cationic antistatic agent or/and an anionic antistatic agent.

2. The polyurethane adhesive of claim 1, wherein the antistatic agent is a combination of an anionic antistatic agent and a cationic antistatic agent at a ratio of the anionic antistatic agent to the cationic antistatic agent ranging from 4.5:1 to 5.5:1.

3. The polyurethane adhesive of claim 1, wherein the ratio of the anionic antistatic agent to the cationic antistatic agent ranging from 5:1 to 5.25:1.

4. The polyurethane adhesive of claim 2, wherein the hydroxyl-containing polysiloxane compound is used in an amount of 4-15 wt % by weight of the polyol.

5. The polyurethane adhesive of claim 2, wherein fatty acid ester is used in an amount of 15 wt % by weight of the polyol.

6. The polyurethane adhesive of claim 2, wherein the polyol has a number-average molecular weight (Mn) of 1500-8,000.

7. The polyurethane adhesive of claim 2, wherein the polyol has a number-average molecular weight (Mn) of 2,000-5,000.

8. The polyurethane adhesive of claim 2, wherein the multi-functional isocyanate compound is one or more selected from the group consisting of a multi-functional aliphatic isocyanate compound, a multi-functional alicyclic isocyanate compound, and a multi-functional aromatic isocyanate compound.

9. The polyurethane adhesive of claim 2, wherein the fatty acid ester is one or more selected from the group consisting of isopropyl laurate, isopropyl myristate, isopropyl palmitate, monobehenin, 2-ethylhexyl stearate, behenic monoglyceride, hexadecyl 2-ethylhexanoate, lauryl methacrylate, coconut fatty acid methyl ester, octyldodecyl myristate, pentaerythritol monooleate, pentaerythritol monostearate, stearyl stearate, methyl laurate, methyl stearate, octyl oleate, isotridecyl stearate, and butyl laurate.

10. The polyurethane adhesive of claim 2, wherein the polyurethane adhesive has a surface resistivity of up to 10⁹Ω/□.

11. The polyurethane adhesive of claim 2, the polyurethane adhesive further has a modifier (D) added, and the modifier (D) is one or more selected from the group consisting of UV absorber, anti-oxidant, preservative, mildew proofing agent, bodying resin, plasticizer, defoamant and wetting agents.

12. A protective film, comprising a substrate layer having a thickness of 10-100 μm, and a cured adhesive layer coated on the substrate layer as well as having a thickness of 1-50 μm, wherein the cured adhesive layer is formed from the polyurethane adhesive of claim 1.

13. The protective film of claim 12, wherein the adhesive layer adheres to a glass plate having an adhesion strength below 5 g/25 mm.

14. The protective film of claim 12, wherein the adhesive layer adheres to a glass plate having an adhesion strength ranged from 1 g/25 mm to 3 g/25 mm.
